(19) United States
(12) Patent Application Publication
(10) Pub. No.: US 2017/0335532 A1
(43) Pub. Date: Nov. 23, 2017

(54) FLEXIBLE DOCK CONNECTOR

(71) Applicant: CMI LIMITED CO., Marietta, GA (US)

(72) Inventor: Allen Jason NAIL, Deltona, FL (US)

(73) Assignee: CMI LIMITED CO., Marietta, GA (US)

(21) Appl. No.: 15/595,558

(22) Filed: May 15, 2017

Related U.S. Application Data
(60) Provisional application No. 62/337,420, filed on May 17, 2016.

(51) Int. Cl. E02B 3/06; F16B 45/00; B63B 35/34

(52) U.S. Cl. CPC E02B 3/064; F16B 45/00; E02B 3/06; B63B 35/34; E02B 3/062

(57) ABSTRACT

A flexible dock connector for connection between two floating dock structures. In example forms, the flexible dock connector includes a first eye bolt, a second eye bolt, a dampening material and a pair of plates. The first and second eye bolts include an eye portion and a bolt portion extending from the eye portion. The eye portions of the first and second eye bolts are coupled together, and the dampening material substantially covers the eye portions of the first and second eye bolts. The pair of plates each include a central opening for receiving the bolt portions of the first and second eye bolts, respectively, and wherein the dampening material is generally sandwiched between the pair of plates.

### CROSS-REFERENCE TO RELATED APPLICATION

This application claims priority to U.S. Provisional Patent Application Ser. No. 62/337,420 filed May 17, 2016, which is hereby incorporated herein by reference in its entirety.

### TECHNICAL FIELD

The present invention relates generally to buoyant or floating docks, piers, walkways and other marine structures; and more particularly to systems, methods and associated components and materials for providing a flexible connection between two or more marine structures.

### BACKGROUND

Floating docks are often used in marine environments for tying off boats and providing access over a water surface. Floating docks maintain buoyancy by floating at least partially atop the water, allowing the dock to move up and down as the water level fluctuates (e.g., by influence from the tide, seasonal water level variations, water level fluctuations resulting from operation of dams for hydroelectric power generation, or other reasons). Other floating marine structures such as piers, walkways, personal watercraft ramps or the like may be utilized with floating docks or independently.

One or more pivoting or hinged connectors are often provided for connecting between two or more dock sections and/or other floating marine structures, or for connection between a floating marine structure and the land or a fixed structure; for example between a floating dock and a walkway, between two floating dock sections, between a seawall and a dock walkway, etc., so that the floating marine structure(s) have at least some freedom to move relative to each other.

Connecting two or more marine structures together with hinged connections generally only allows for movement therebetween in one dimension (typically vertically). Hinged connections are also commonly known to become noisy during movement between the floating docks, which is typically seen as a drawback to hinged connectors. Hinged connections are also prone to wear and breakage. Connecting floating docks and/or other marine structures with bolted connections generally does not allow for much (if any) freedom of movement between the floating docks. Where bolts are used for connecting marine structures together, movement between the structures can overstress the bolts and lead to failure of the connections and damage to or loss of the structures, especially in rough water conditions.

Thus it can be seen that needs exist for improvements in the field of connections for marine structures. It is to the provision of improved connectors, methods and associated components and systems for connecting floating docks and/or other marine structures together meeting these and other needs that the present invention is primarily directed.

### SUMMARY

In example embodiments, the present invention provides a flexible dock connector for connection between floating docks and/or other marine structures. In example forms, the flexible dock connector preferably allows for movement of the floating dock structures relative to each other in two or three dimensions (i.e., horizontally and vertically). The connector preferably provides dampening of motion between the connected structures, and a fail-safe connection wherein connection between the structures is maintained even in the event of a failure of a first component of the connector.

In one aspect, the present invention relates to a flexible dock connector including a first eye bolt, a second eye bolt, a dampening material and a pair of plates. The first eye bolt includes an eye portion and a bolt portion extending from the eye portion for connection to a first marine structure. The second eye bolt includes an eye portion and a bolt portion extending from the eye portion for connection to a second marine structure. In example forms, the eye portion of the second eye bolt is interlinked or otherwise coupled together with the eye portion of the first eye bolt. The dampening material substantially covers at least the interconnected eye portions of the first and second eye bolts. The pair of plates each includes a central opening for receiving the bolt portions of the first and second eye bolts, respectively. The dampening material is generally sandwiched between the pair of plates.

In example embodiments, the bolt portions of the first and second eye bolts include threads. At least one washer and at least one compatibly threaded nut are optionally provided for connection with the threaded bolt portions of the first and second eye bolts. In particular example embodiments, the first and second eye bolts can be nominal ¾″ diameter and formed from stainless steel, or alternatively can be other dimensions and/or other materials including other types of steel (e.g. galvanized), brass, other metal, a composite material or other substantially rigid structural material. In example embodiments, the dampening material comprises a natural or synthetic rubber. In particular example embodiments, the rubber is in the form of ethylene propylene diene monomer rubber. The plates of the connector may be formed from stainless steel or other materials compatible with freshwater and/or saltwater marine environments.

In another aspect, the invention relates to a marine dock system including at least one floating dock structure and at least one other marine structure connected to the floating dock structure by at least one flexible dock connector. In example embodiments, the flexible dock connector includes a first end and a second end for coupling the dock structures together. In example embodiments, each of the first and second dock structures include a connecting end, and wherein the connecting end includes a connecting end face. The other marine structure can be another floating dock structure, a walkway, a pier, a seawall, and/or other floating or stationary equipment or structure(s).

In example embodiments, the first end of the flexible dock connector is coupled to the floating dock structure and the second end of the flexible dock connector is coupled to the other marine structure. In example embodiments, the flexible dock connector includes a first eye bolt, a second eye bolt, a dampening material and a pair of plates. In example embodiments, the first and second eye bolts include an eye portion and a bolt portion extending from the eye portion, and wherein the eye portions of the first and second eye bolts being coupled together. In example embodiments, the dampening material substantially covers the eye portions of the first and second eye bolts. In example embodiments, the pair of plates each includes a central opening for receiving the bolt portions of the first and second eye bolts, respectively, and wherein the dampening material is generally sandwiched between the pair of plates. In example embodiments, the first and second floating dock structures each include at least one buoyant member for providing buoyancy to the respective dock structure.

In still another aspect, the invention relates to a method of manufacturing a flexible dock connector including providing a first and a second eye bolt, each of the first and second eye bolts comprising an eye portion and a bolt portion extending from the eye portion; connecting the eye portion of the first eye bolt to the eye portion of the second eye bolt; providing a first and a second plate, each of the plates comprising a central opening extending therethrough; positioning the opening of the first plate on the bolt portion of the first eye bolt; fixedly engaging the first plate with the bolt portion of the first eye bolt; positioning the opening of the second plate on the bolt portion of the second eye bolt; fixedly engaging the second plate with the bolt portion of the second eye bolt; and providing a dampening material substantially around the connection of the eye portions of the first and second eye bolts and between the first and second plates.

In example embodiments, at least a portion of the bolt portions of the first and second eye bolts include threads. In example embodiments, the method further includes providing a washer and a threaded nut for engagement with each of the bolt portions of the first and second eye bolts.

In still another aspect, the invention relates to a flexible connector for joining a first structure to a second structure and allowing relative movement between the first and second structures. The flexible connector preferably includes a first connection portion including at least two interlinked rigid components, and a second connection portion comprising an elastic material at least partially surrounding the interlinked rigid components of the first connection portion. In example embodiments, the interlinked rigid components can be one or more eyebolts, links of a chain, or other interlinked metal parts, and the elastic material can be a synthetic or natural rubber.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a perspective view of a flexible dock connector according to an example embodiment of the present invention.

FIG. 2 is a perspective view of two marine structures connected together with a pair of the flexible dock connectors as shown in FIG. 1.

FIG. 3 is a cross-sectional view of the flexible dock connector of FIG. 1.

FIG. 4 is an end view of the flexible dock connector of FIG. 1.

FIG. 5 is a top view of the two marine structures of FIG. 2, connected together with flexible dock connectors.

FIG. 6 is a side perspective view of the two marine structures connected together with flexible dock connectors, and showing one of the structures raised or inclined relative to the other structure.

FIG. 7 shows a side view of two marine structures connected together by flexible dock connectors, with the structures being aligned and having their top surfaces positioned at a similar height and being generally co-planar relative to each other.

FIG. 8 shows a side view of the two marine structures of FIG. 7, with one of the structures being raised or inclined at an angle relative to the other structure.

FIG. 9 shows a detailed view of the connection of the marine structures of FIG. 7.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

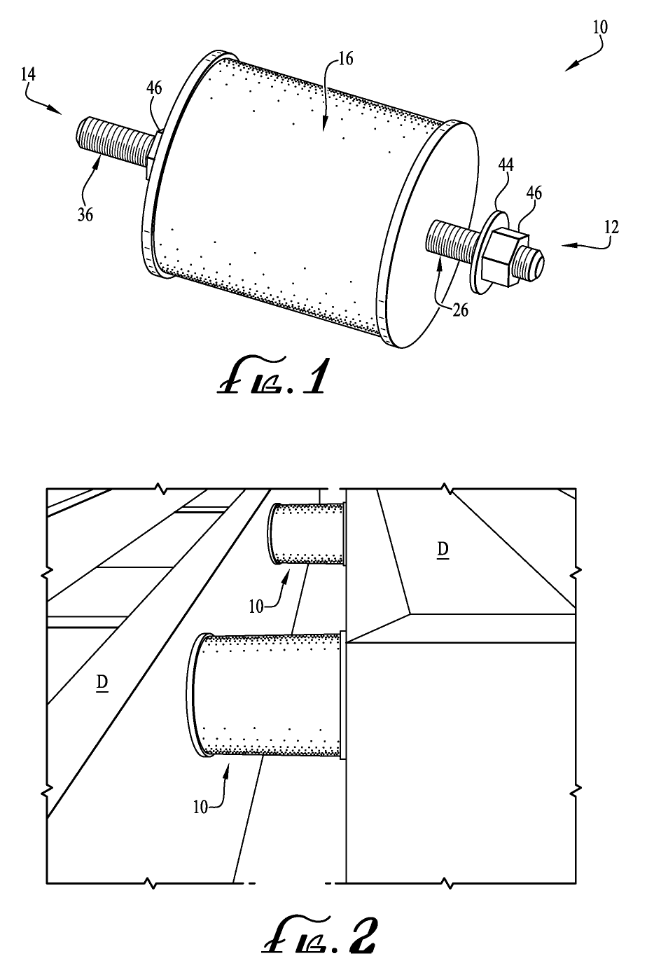

With reference now to the drawing figures, wherein like reference numbers represent corresponding parts throughout the several views, FIG. 1 shows a flexible dock connector 10 according to an example embodiment of the present invention. As depicted, the flexible dock connector 10 is generally elongate, extending from a first end 12 to a second end 14, and comprises a generally cylindrical body 16 having an outer periphery extending at least partially along the midsection of the connector 10. In alternative embodiments, the body 16 of the connector 10 can be shaped as desired, for example, to have a square, rectangular or other cross-sectional shape to form a body that is generally cubic, rectangular, oval, polygonal, etc.

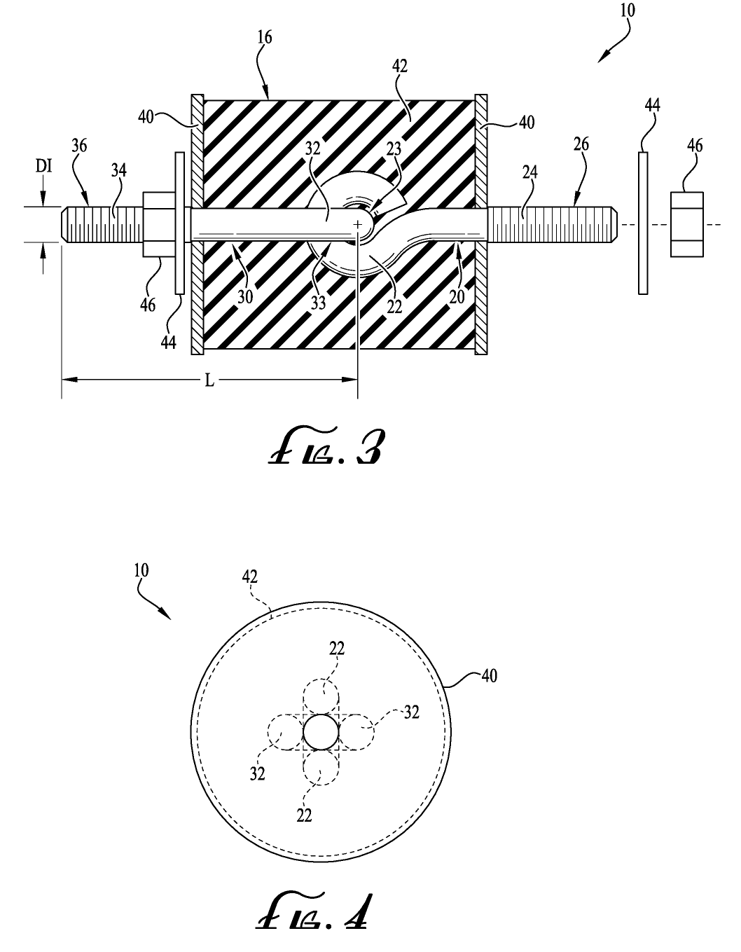

In example embodiments, bolt portions 26, 36 extend from each end of the cylindrical-shaped body 16, and thereby define the first and second ends 12, 14 (see FIG. 3). The bolt portions 26, 36 extend through portions of generally adjacent and spaced-apart floating platforms, structures, or docks D, respectively, such that the flexible dock connector 10 provides for securely connecting floating docks D together (see FIG. 2). In example embodiments, the bolt portions 26, 36 comprise threaded portions 24, 34, respectively, such that a washer 44 and a threaded fastener or nut 46 can be received thereon such that the ends 12, 14 of the connector 10 can be securely fastened to the respective dock D. In alternative example embodiments, one or more lock washers, lock nuts, thread engagement lubrications, cotter pins, etc. can be used for connecting (either permanently or removably) the ends 12, 14 with the respective docks 10. While described herein with respect to example embodiments wherein two floating dock structures D are connected by the flexible dock connector 10, it will be understood that the invention likewise includes the connection of any two or more marine structures, including docks, piers, walkways, personal watercraft ramps, and/or other floating or stationary structures or equipment. Also, while described herein with respect to example embodiments wherein a pair of flexible dock connectors 10 are coupled between adjacent marine structures, the invention likewise includes the connection of structures using one, two, three, four or more connectors, horizontally, vertically or otherwise aligned, or positioned in various spaced arrays relative to one another.

In example embodiments, the flexible dock connector 10 permits three-dimensional movement of the docks D relative to each other, for example, to provide for movement and flexibility of the floating docks D relative to each other, for example, which could be caused by impact from an external object (e.g., boat, etc.), excess movement and weight being applied to the upper surface or deck of the dock, by placement of the docks D on an unlevel ground surface, or by turbulent and substantially choppy or rough water conditions. For example, the flexible dock connector 10 permits two or more degrees of freedom of movement between coupled structures, e.g., vertical movement up and down, horizontal movement from side to side, pivotal or hinged angular movement up and down and/or from side to side, extension, and/or contraction.

As depicted in FIGS. 3-4, according to example embodiments, the flexible dock connector 10 comprises first and second eye bolts 20, 30, a pair of plates 40, a pair of washers and nuts 44, 46, and a filler or dampening material 42. As depicted in FIG. 3, the eye bolts 20, 30 each comprise a hook or eye portion 22, 32, and a bolt portion 26, 36 extending from the eye portion 22, 32. In example embodiments, at least a portion of the bolt portion 26, 36 comprises threads 24, 34, for example, for providing interengagement with the nuts 46. In example embodiments, the eye portion 22 of the first eye bolt 20 is interlinked or otherwise coupled with the eye portion 32 of the second eye bolt 30, for example, such that a pivotal connection is provided therebetween. Preferably, the pivotal connection between the eye portions 22, 32 is such that the eye bolts 20, 30 can pivot in three dimensions, or for example, wherein the bolt portions 26, 36 can be pivoted generally up-and-down, side-to-side, or about a plurality of angles relative to each other.

In particular embodiments, the first and second eye bolts 20, 30 are sized to have a nominal diameter DI of about 0.75 inches (¾″) and have a length L of about 5.875 (5⅞″) inches defined between a center point of an opening 23, 33 defined at the eye portions 22, 32 of the eye bolts 20, 30 and the ends of the bolt portions 24, 34. Optionally, other diameters or lengths greater or less than the particular examples described herein can be used as desired.

For example, according to one example embodiment, the openings 23, 33 of the eye portions 22, 32 comprise a diameter of at least about 0.75 inches. According to some example embodiments, the diameter of the openings 23, 33 is between about 0.875 inches to about 1.25 inches. Preferably, as described above, the extension/stretching and compression/contraction of the flexible dock connector 10 can be provided by sizing the openings 23, 33 of the eye portions 22, 32 such that at least some play or spacing is provided therebetween, for example, such that the eye bolts 20, 30 can displace axially relative to each other. In example embodiments, the amount of axial play between the bolts 20, 30 can be controlled by the difference in the diameter of the openings 23, 33 relative to the diameter DI of the bolts (e.g., and eye portion). For example, when the diameter of the openings 23, 33 is about 1.25 inches and the diameter DI of the bolts 20, 30 is about 0.75 inches, the connected eye bolts 20, 30 have an allowable axial displacement of about 0.50 inches.

According to one example embodiment, with the openings 23, 33 of the eye portions 22, 32 being at least partially larger than the diameter DI of the bolts 20, 30, the eye portions 22, 32 are generally centered in each other's openings 23, 33 prior to covering the connection with the dampening material 42. Thus, depending on the difference between the diameter of the openings 23, 33 and the diameter DI of the bolts 20, 30, the bolts 20, 30 can preferably allow at least some axial displacement on both the tension and compression directions, for example, in addition to the up/down and side-to-side movement as described above. In alternate embodiments, the eye portions 22, 32 are not centered within each other's openings 23, 33 such that axial displacement can only be provided in either the extension/tension direction or the compression/contraction direction, for example, such that any play in the axial direction is minimized or entirely eliminated.

In example embodiments, each of the plates 40 comprises a disk having a generally centrally-positioned opening extending therethrough, dimensioned for mounting engagement on the eye bolts 20, 30. The plates 40 can be formed from stainless steel, aluminum or other metals or other materials as desired, and are preferably compatible with freshwater or saltwater marine environments. In particular embodiments, the centrally-positioned opening is generally at least about 0.75 inches in diameter, the diameter of the plate 40 is about 5.5 inches, and the thickness of the plate is about 0.25 inches. Optionally, the pair of plates 40 can be sized as desired, for example, having a diameter, thickness that is greater or less than the example dimensions as described herein. The centrally-positioned opening is preferably at least large enough such that the bolt portions 24, 34 of the particular embodiment can extend therethrough. For example, according to one example embodiment, when the diameter DI of the bolts 20, 30 is about 0.75 inches, the opening of each plate is generally at least sized to be about 0.75 inches or partially greater to accommodate being received by the respective bolt. According to one example embodiment, the openings of the plates 40 are sized to receive the bolt portions 26, 36 whereby at least some tolerance is provided therebetween however having a proper fit for allowing for permanently connecting the plates 40 with each respective bolt portion 26, 36, for example, by welding or another permanent connection.

One of the plates 40 is retained on the bolt portion 24 of the first eye bolt 20, and the other plate 40 is retained on the bolt portion 34 of the second eye bolt 30. The plates 40 can be permanently connected to the eye bolts 20, 30, for example, by welding, adhesives, etc., or can be attached by fasteners or otherwise. For example, according to example embodiments, each plate 40 is welded to its respective eye bolt 20, 30 along the centrally-positioned opening along an interior face of each plate 40 (e.g., the faces of the plates 40 facing each other). In example embodiments, each plate 40 is secured to its respective eye bolt 20, 30, for example, such that the plate 40 is oriented substantially perpendicular relative to the extension of the bolt portions 24, 34. As depicted in FIG. 3, according to example embodiments of the present invention, the plates 40 are generally permanently mounted to the eye bolts 20, 30 such that the bolt portions 24, 34 extend outwardly about 2.75 inches (2¾″) from the plates 40.

In example embodiments, a dampening material 42 is provided between the plates 40 and generally surrounds the entirety of the pivotal coupling engagement of the eye portions 22, 32 of the eye bolts 20, 30. In example embodiments, and with the eye bolts 20, 30 generally axially aligned with each other and oppositely extending therefrom, a rubber or generally at least partially elastic and flexible material is molded to generally remain confined between the two plates 40, but at least partially surround the connected eye portions 22, 32. Thus, in example embodiments, the dampening material 42 is over-molded or molded over (and at least partially surrounds) the pivotal connection of the first and second eye bolts 20, 30. In example embodiments, the dampening material 42 preferably provides for dampening or adding at least some rigidity to the pivotal connection of the first and second eye bolts 20, 30. In example embodiments, the dampening material 42 comprises a rubber material in the form of ethylene propylene diene monomer (EPDM) rubber. Generally, the properties of the EPDM are such that it has a durometer range of between about 20-90. In alternate example forms, the dampening material can be formed from other materials, for example, other synthetic or natural rubbers, plastics, polymers, composites, or other at least partially flexible and resilient materials.

In example embodiments, a cylindrical mold or member can be positioned between the plates 40 and around the connection of the eye portions 22, 32, for example, such that a material (e.g., generally in a substantial liquid form) can be poured or injected within a cavity defined between the plates 40 and within the cylindrical mold, which is then removed from the mold to define the dampening material 42, which is at least partially surrounding the connection of the eye portions 22, 32 and between the plates 40. In example forms, the molded dampening material 42 defines a substantially uniform cylindrical profile extending between the plates 40. In example embodiments, the diameter of the uniform cylindrical profile of the dampening material is generally slightly smaller than the diameter of the plates 40, for example, such that the outer profile generally at least partially reduces in diameter from the plate 40 to the uniform cylindrical profile of the dampening material 42.

In alternate example embodiments, the dampening material 42 can be formed around the eye bolts 20, 30 and between the plates 40 such that at least one or more channels or recesses are formed within the dampening material 42 and generally extend to expose at least a portion of one or more of the eye bolts 20, 30. For example, in some example embodiments, the one or more channels or recesses formed in the dampening material 42 can influence the flexibility of the flexible dock connector 10. Thus, in addition to controlling the flexibility by the dampening material 42 itself (e.g., depending on the durometer value, etc.), the one or more channels or recesses formed within the dampening material can additionally affect the flexibility of the connector 10. According to another example form, one or more cylindrical rods can be temporarily fastened between the plates 40 such that after pouring the molded dampening material 42, the cylindrical rods can be removed such that one or more generally elongate voids are formed within the molded dampening material 42. According to example embodiments, the one or more voids formed within the dampening material 42 preferably provide at least some flexibility compared to no voids formed within the molded dampening material.

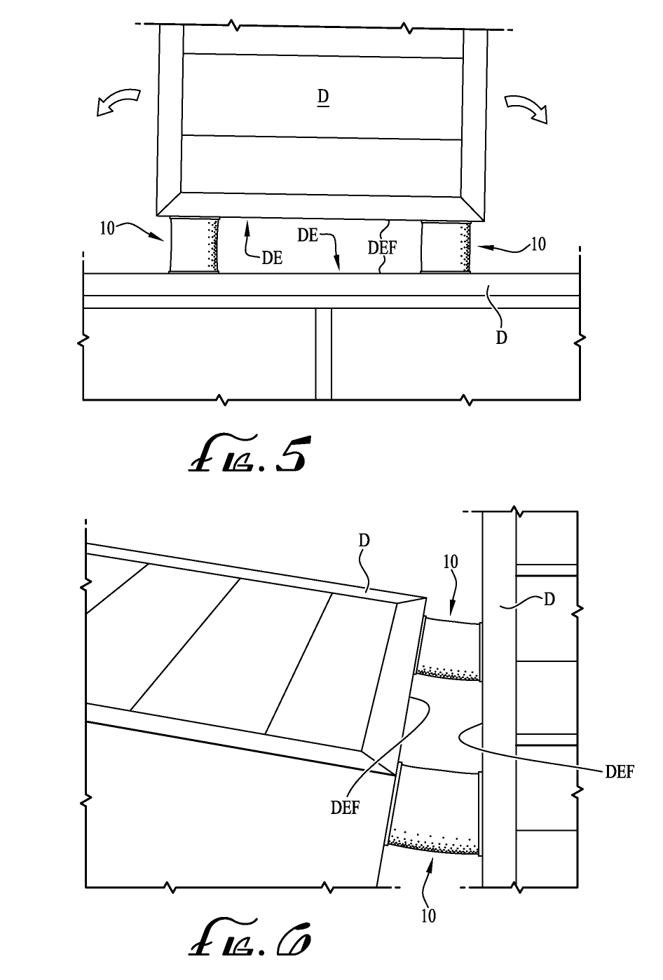

FIGS. 5-9 show marine structures in the form of floating docks D having flexible dock connectors 10 connecting the floating docks D together. As shown in FIG. 5, the floating docks D generally comprise a generally rectangular geometry, and comprise connecting ends DE and connecting end faces DEF. According to example embodiments, one or more flexible dock connectors 10 are positioned between the connecting ends and engage the connecting end faces DEF, for example, wherein the plates 40 are generally in contact with the connecting end faces DEF and the bolt portions 26, 36 extend entirely through the connecting end faces DEF for receiving a washer 44 and a nut 46, for example, to secure the flexible dock connector 10 therebetween. In example embodiments, at least two flexible dock connectors 10 are provided per connection between adjacent marine structures, and are preferably positioned along a substantially similar horizontal line or plane of connection. In example embodiments, when the floating docks D are connected together by the flexible dock connectors 10, the connecting end faces DEF are at least partially spaced-apart and generally parallel with each other. In this manner, the top surfaces of the docks D are generally aligned or co-planar when the connectors are in a neutral state, and are maintained in close proximity to one another as the connectors flex or move, so that a user can easily step from one structure to the other.

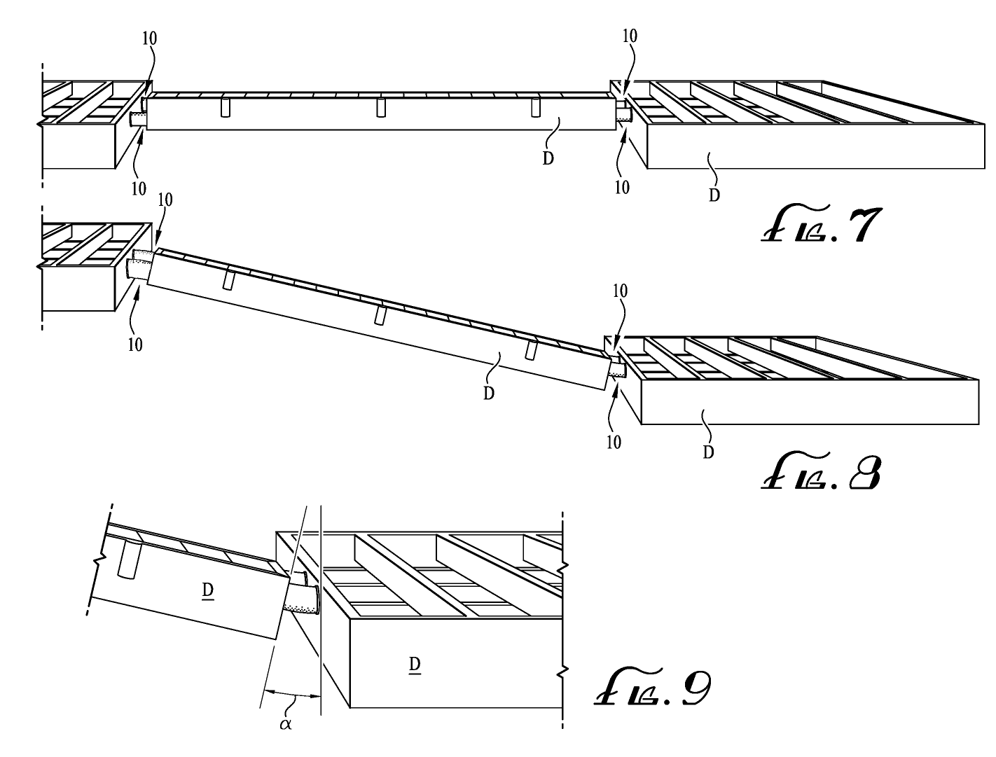

As depicted in FIGS. 5-6, one of the docks D comprises a substantially smaller dimension that the other floating dock D, and thus, two flexible dock connectors 10 are provided for connecting the two floating docks D together. For example, one of the dock structures D can be a larger dock platform, and the other a smaller dock extension, a walkway or other marine structure. At least one end (the connected end) of each structure D is movable or floating, allowing the structure to rise or fall relative to the land or other stationary point of reference, for example as the water level in which the structure floats fluctuates. For example, the entire larger dock structure may float up and down with the water level, and the smaller walkway or ramp may be pivotally connected to a seawall or other fixed structure at one end and pivotally connected to the larger dock structure at the other end (also see FIGS. 7-8). In example embodiments, the flexible dock connectors 10 are laterally offset inwardly from the outer sides of the smaller-dimension floating dock D, and are positioned along a substantially similar horizontal plane. In alternate example embodiments, for example, wherein the connecting end faces DEF have a substantially large dimension, three or more flexible dock connectors 10 can be provided as desired.

In example embodiments, the flexible dock connectors 10 preferably provide a secure connection between adjacent sections of floating docks D or other marine structures while allowing for at least some movement and flexibility therebetween, for example to accommodate for moving up and down with changing water levels, absorbing movement from choppy or rough water conditions, wind or other external forces being applied to the one or more docks, etc. As shown in FIGS. 6 and 9, one of the floating docks D can move pivotally at an angled inclination relative to the other floating dock D, for example, in an up-and-down vertical dimension wherein an upper surface or platform of one of the docks is substantially angled relative to an upper surface or platform of the other floating dock D. As depicted in FIG. 9, an angle α is defined between the docks D, which can be between about 0-45 degrees, more preferably between about 0-40 degrees, and more preferably between about 0-35 degrees according to one example embodiment. Furthermore, with the flexible dock connectors 10 coupling the floating docks D together, the floating docks D are generally capable of at least some side-to-side movement (see arrows in FIG. 5), for example, along a horizontal axis that is generally parallel with the upper surfaces or platforms of the docks D. Moreover, the flexible dock connectors 10 allow for other relative movement between the docks D, for example, which can be a combination of up-and-down and side-to-side movements, for example, such that the flexible dock connectors 10 allow for three-dimensional movement of the docks D relative to each other.

In another example embodiment, the present invention relates to a method of manufacturing a flexible dock connector 10. The method includes providing a first and a second eye bolt 20, 30, each of the first and second eye bolts 20, 30 comprising an eye portion 22, 32 and a bolt portion 26, 36 extending from the eye portion 22, 32; connecting the eye portion 22 of the first eye bolt 20 to the eye portion 32 of the second eye bolt 30; providing a first and a second plate 40, each of the plates 40 comprising a central opening extending therethrough; positioning the opening of the first plate 40 on the bolt portion 26 of the first eye bolt 20; fixedly engaging the first plate 40 with the bolt portion 26 of the first eye bolt 20; positioning the opening of the second plate 40 on the bolt portion 36 of the second eye bolt 30; fixedly engaging the second plate 40 with the bolt portion 36 of the second eye bolt 30; and providing a dampening material 42 substantially around the connection of the eye portions 22, 32 of the first and second eye bolts 20, 30 and between the first and second plates 40. In example embodiments, the method further includes providing a washer 44 and a threaded nut 46 for engagement with each of the bolt portions of the first and second eye bolts.

According to an alternate example embodiment, one or more intermediate link(s) are connected between the eye portions 22, 32. For example, in one embodiment, one or more links of chain (or other linked connecting members) can be coupled between the eye portions 22, 32 wherein the dampening material 42 substantially surrounds both the eye portions 22, 32 and the one or more link(s). Alternatively, one or more link(s) of chain or other connecting members can be surrounded by the dampening material 42 without the eye bolts 20, 30.

In example embodiments, the flexible dock connector 10 as described herein preferably provides for a secure and flexible connection between to floating docks D. The rubber dampening material provides a first connection component between adjacent connected marine structures and provides a dampening effect to limit relative movement therebetween, while the interlinked eyebolts provide a fail-safe connection even in the event of failure or separation of the rubber dampening material. In example embodiments, rather than over molding the dampening material to substantially cover the connection between the two eye bolts, a sleeve or other member can be provided for at least partially covering the connection, or for example, a member comprising at least some rigidity can be provided for generally stiffening the connection between the two eye bolts. Preferably, the member for providing rigidity allows for at least some flexibility such that the eye bolts can at least partially move or pivot relative to each other. In additional example embodiments, one or more resilient springs, partially flexible members or sleeves, couplings, connectors, or other fasteners can be provided for coupling floating docks D together, for example, such that the floating docks D are secured together but can at least partially move or flex relative to each other.

According to another example embodiment of the present invention, two or more flexible dock connectors 10 can be combined together into a one-piece connector. For example, rather than comprising only first and second eye bolts 20, 30 with the bolt portions 26, 36 oppositely extending outwardly for connecting to respective connecting end faces DEF, two or more pairs of eye bolts 20, 30 can be generally laterally offset from each other wherein the dampening material 42 at least partially covers or encapsulates each of the pivotal connections of the eye portions 22, 32 to form one unitary connector. Thus, according to some example embodiments, the flexible dock connector of the present invention can have two or more bolt portions extending from the ends thereof. As such, according to some example embodiments, the flexible dock connector can comprise two or more bolt portions extending from each end for connecting to respective connecting end faces DEF.

While the invention has been described with reference to example embodiments, it will be understood by those skilled in the art that a variety of modifications, additions and deletions are within the scope of the invention, as defined by the following claims.

What is claimed is:

1. A flexible dock connector comprising:
a first eye bolt comprising an eye portion and a bolt portion extending from the eye portion;
a second eye bolt comprising an eye portion and a bolt portion extending from the eye portion, the eye portion of the second eye bolt being coupled with the eye portion of the first eye bolt; and
a dampening material at least partially covering the eye portions of the first and second eye bolts.

2. The flexible dock connector of claim 1, further comprising a pair of plates each comprising a central opening for receiving the bolt portions of the first and second eye bolts, respectively, and wherein the dampening material is generally sandwiched between the pair of plates.

3. The flexible dock connector of claim 1, further comprising threads on a least a portion of the bolt portions of each of the first and second eye bolts.

4. The flexible dock connector of claim 1, further comprising at least one washer and at least one threaded nut for connection with the bolt portions of the first and second eye bolts.

5. The flexible dock connector of claim 1, wherein the dampening material comprises rubber.

6. The flexible dock connector of claim 1, wherein the dampening material comprises ethylene propylene diene monomer.

7. The flexible dock connector of claim 2, wherein the pair of plates are formed from stainless steel.

8. A marine system comprising:
a first marine structure;
a second marine structure; and
a flexible dock connector having a first end connected to the first marine structure, a second end connected to the second marine structure and a dampening body portion defined between the ends thereof, the flexible dock connector allowing at least two degrees or dimensions of movement between the first and second marine structures.

9. The marine system of claim 8, wherein each of the first and second marine structures comprise a connecting end, and wherein the connecting end comprises a connecting end face.

10. The marine system of claim 9, wherein the first end of the flexible dock connector is coupled to a connecting end face of the first marine structure and wherein the second end of the flexible dock connector is coupled to a connecting end face of the second marine structure.

11. The marine system of claim 8, wherein the flexible dock connector comprises a first eye bolt, a second eye bolt, the dampening body portion and a pair of plates, the first and second eye bolts each comprise an eye portion and a bolt portion extending from the eye portion, the eye portions of the first and second eye bolts being coupled together, the dampening body portion substantially covering the eye portions of the first and second eye bolts, the pair of plates each comprising a central opening for receiving the bolt portions of the first and second eye bolts, respectively, and wherein the dampening body portion is generally sandwiched between the pair of plates.

12. The marine system of claim 8, wherein at least one of the first and second marine structures comprises a buoyant member for providing buoyancy to the respective dock structure.

13. A method of manufacturing a flexible dock connector comprising:
providing a first and a second eye bolt, each of the first and second eye bolts comprising an eye portion and a bolt portion extending from the eye portion;
connecting the eye portion of the first eye bolt to the eye portion of the second eye bolt;
at least partially encapsulating the connected eye portions of the first and second eye bolts within a dampening material.

14. The method of manufacturing a flexible dock connector of claim 13, wherein at least a portion of each bolt portion of the first and second eye bolts comprises threads.

15. The method of manufacturing a flexible dock connector of claim 14, further comprising providing a washer and a threaded nut for engagement with each of the bolt portions of the first and second eye bolts.

16. A flexible connector for joining a first structure to a second structure and allowing relative movement between the first and second structures, the flexible connector comprising:
a first connection portion comprising at least two interlinked rigid components; and
a second connection portion comprising an elastic material at least partially surrounding the interlinked rigid components of the first connection portion.

17. The connector of claim 16, wherein the interlinked rigid components comprise eyebolts having interlinked eye portions and threaded bolt portions extending from the eye portions.

18. The connector of claim 16, wherein the first and second structures are marine structures selected from dock sections, walkways, ramps and/or piers, and wherein at least one of the first and second structures is buoyant for floating in water.
